(19) United States
(12) Patent Application Publication
(10) Pub. No.: US 2023/0089640 A1
(43) Pub. Date: Mar. 23, 2023

(54) METHOD FOR DISCHARGING BATTERY MODULES AND CONTROL DEVICE

(71) Applicant: AUDI AG, Ingolstadt (DE)

(72) Inventors: Dirk BÄDER, Fellbach (DE); Michael GRABOWSKI, Ingolstadt (DE)

(73) Assignee: AUDI AG, Ingolstadt (DE)

(21) Appl. No.: 17/949,621

(22) Filed: Sep. 21, 2022

(30) Foreign Application Priority Data
Sep. 22, 2021 (DE) 10 2021 124 473.0

(51) Int. Cl. H01M 10/44; H01M 10/42; H02J 7/00

(52) U.S. Cl. CPC H01M 10/441; H01M 10/443; H01M 10/4257; H02J 7/0013; H02J 7/0029; H02J 7/0048; H02J 7/00712; B60R 16/033; H01M 2010/4271; H01M 2220/20

(57) ABSTRACT

A method of discharging battery modules of a battery in case of a fault state of at least one of the battery modules, a respective battery module of the plurality of battery modules having at least one battery cell includes, under at least one first condition that at least one first battery cell of a first battery module of the plurality of battery modules has at least one critical state, respective second battery modules, from among the battery modules which are different from the first battery module are at least partly discharged in accordance with an order at least under a second condition. The order depending on a spatial distance between the respective second battery modules different from the first battery module and the first battery module and/or depending on a thermal resistance between the respective battery modules different from the first battery module and the first battery module.

### CROSS-REFERENCE TO RELATED APPLICATIONS

This application claims the priority benefit under 35 USC 119 of German Application No. 10 2021 124 473.0 filed on Sep. 22, 2021. The German Application is incorporated by reference herein in entirety.

### FIELD

The present description relates to a method for discharging battery modules of a battery in the case of a fault state of at least one of the battery modules, a respective one of the plurality of battery modules having at least one battery cell. Furthermore, the present description also relates to a control device for a motor vehicle for controlling discharging of battery modules.

### BACKGROUND

The prior art discloses that battery cells or battery modules can be discharged in the case of a defect, in particular in the case of a thermal runaway.

By way of example, DE 10 2016 224 002 A1 describes discharging of at least one battery module of a battery, the battery cells of the battery module being arranged adjacent to one another, and the battery cells of the battery module to be discharged being selectively electrically coupled successively to a discharge device by means of the cell switching unit, proceeding from a predefined battery cell, in order to electrically discharge the battery cells individually in succession for the purpose of discharging the battery module. In that case, the battery cell exhibiting a defective or disturbed state can be discharged first, and then for example the spatially adjacently arranged battery cells. The location of a possible fault source is thereby intended first and foremost to be deactivated from an energy engineering standpoint.

Furthermore, DE 10 2018 203 164 A1 describes a safety system for carrying out an emergency discharge function at a battery, wherein, as soon as the risk of a thermal runaway at a battery cell of the battery is detected, a short circuit is produced in order to carry out the emergency discharge function at least at a battery cell adjacent to the battery cell undergoing runaway and/or at at least one module having a plurality of battery cells that neighbors the battery module with the battery cell undergoing runaway.

The previous methods may have the disadvantage that discharging takes a very long time, for example if individual battery cells are discharged slowly in succession, or, on the other hand, as a result of rapid discharging. For example as a result of short-circuiting of individual cells, the thermal runaway of these cells is only additionally promoted since, for example, the short-circuiting of a cell entails extremely severe heating of such a cell, which is precisely a reason why short circuits of cells also constitute one of the causes of a thermal runaway of cells.

### SUMMARY

Described may be a method and a control device which allow a thermal runaway of a battery to be counteracted as efficiently as possible.

Described may be a method and a control device having the features according to the respective independent patent claims. Example advantageous configurations may also be the subject matter of the dependent patent claims, the description and the figures.

In a method of discharging battery modules of a battery in the case of a fault state of at least one of the battery modules, a respective one of the plurality of battery modules has at least one battery cell. In this case, under the at least one condition that at least one first battery cell of a first battery module of the plurality of battery modules has at least one specific critical state, up to all (subsets of) respective second battery modules, from among the battery modules, which are different from the first battery module may at least be partly discharged in accordance with a predetermined order at least under a second condition, the order being defined depending on a spatial distance between the respective battery modules different from the first battery module and the first battery module and/or depending on a thermal resistance between the respective battery modules different from the first battery module and the first battery module.

A fault state is thus present if at least one battery cell has the at least one specific critical state. In this case, a major advantage may be that the discharging here is neither restricted to the battery module having the battery cell having the specific critical state, nor restricted to the immediate vicinity thereof. The method may advantageously enable ordered discharging of all battery modules in a predetermined order that takes account of the spatial distance with respect to the defective module, which in the present case may be referred to as the first battery module, and/or the thermal properties of these thermal transfer paths from the defective module to the other battery modules. For simplification, the thermal resistance between the first battery module and the battery modules different from the first battery module may also referred to as thermal distance. In other words, the thermal distance from the first battery module to a battery module different from the first battery module can be characterized by the thermal resistance of the region, including all components, structural parts and free regions arranged in the region, between the first battery module and the battery module different from the first battery module. The thermal resistance may be specified in K/W (kelvins per watt) as a unit. The spatial distance is implicitly also already taken into account in the thermal resistance since the latter decreases with increasing distance with respect to the first module. However, this decrease need not be linear, but rather may in turn depend on the thermal resistance of the voids, structural parts, etc. situated in the intermediate region. The method may in turn be based on the insight that in the case of a thermal runaway of a battery cell or of a battery module, such a thermal runaway, precisely if the relevant battery module catches fire, can propagate extremely rapidly to all the other battery modules, not just to the adjacent battery modules. In this case, a thermal runaway of a battery cell generally begins with slow heating thereof until said battery cell ultimately outgases. During the outgassing of such a battery cell, extremely hot gases emerge in this case from the relevant battery cell, which gases also entrain electrically conductive particles and highly inflammable constituents, as a result of which, in principle, a fire can also easily occur at the relevant battery cell. Moreover, the emerging gases lead to very rapid heating of adjacent battery cells, which then for their part in turn undergo thermal runaway, resulting in thermal propagation in the entire battery. In this case, the initial heating phase in the course of such a thermal runaway until the outgassing of such a battery cell may have a very long duration, under certain circumstances, and in particular may even last for hours. If such a battery cell catches fire, however, then such a fire propagates over the entire battery within a very short time, in particular within minutes or seconds, which however in turn may depend on the state of charge of the battery or of the individual battery modules and cells thereof. If targeted discharging of all battery modules in accordance with the predetermined order is initiated as early as upon detection of a specific critical state of at least one first battery cell of the first battery module, then thermal propagation can be counteracted with maximum efficiency. If a relevant battery module were discharged only in the event of this battery module itself comprising a cell undergoing thermal runaway, then it is often already distinctly too late to be able to actually still stop thermal propagation. Even if only the directly adjacent battery modules were discharged, thermal propagation, precisely in the case of very long discharge times, cannot thereby be counteracted as efficiently as is made possible by timely discharging of all battery modules. By virtue of the predetermined order defined depending on the spatial and/or thermal distance between the respective battery modules and the affected first battery module, it is additionally possible to define a specific prioritization during the discharging of the battery modules, such that the battery modules closest to the first battery module or the battery modules to which the heat propagates the most rapidly proceeding from the defective module may be discharged first, in particular provided that the battery modules closest to the first battery module or the battery modules to which the heat propagates the most rapidly proceeding from the defective module satisfy the predetermined second condition mentioned above. This makes it possible, moreover, to define further discharge criteria. The discharging of all battery modules in accordance with said predetermined order now makes it possible that, even in the case of a thermal runaway of a battery cell or of a battery module, there is a very high probability that the battery does not catch fire at all and thermal propagation can even be stopped. Defining a predetermined order is particularly advantageous primarily if the discharge resources may be limited, that is to say if only a limited amount of energy per time can be dissipated from the cells or the battery. By virtue of an order defined depending on the spatial and/or thermal distance from the first battery module, it may thus advantageously be possible to implement a star-shaped discharge concept, for example, which is also referred to hereinafter as “star method”, in which in particular all spatial directions, rather than just a single spatial direction, can be taken into account equivalently in the same way. Said order can be defined beforehand for each of the battery modules as first battery module for example depending on a given spatial arrangement of the battery modules with respect to one another, optionally also taking account of the thermal resistances between the battery modules, and can be stored for example in a memory of a control device. In this regard, for the case where the specific critical state is detected for one of the battery modules, which in the present case may be referred to as first battery module, firstly for the spatially closest battery modules a check can be made to ascertain whether the spatially closest battery modules satisfy the predetermined second condition and, if that is so, these can be discharged; afterward, for the closest battery modules in accordance with the predetermined order, a check can be made to ascertain whether the spatially closest battery modules satisfy the predetermined second condition and, if so, these may be discharged, and so on until ultimately all of the battery modules have been discharged. In order to initiate this progressive discharging, it may thus be sufficient for only a single battery module or else only a single battery cell to have a specific critical state. It is thus possible to realize a discharge with maximum efficiency and safety.

Furthermore, this discharge strategy can be realized not just at the module level, but also entirely analogously at the battery cell level. In this regard, for example, battery cells situated closer to the affected battery cell can be assigned a higher discharge preference than battery cells further away, in particular independently of their association with the same battery module. Accordingly, it may be a further advantageous configuration if, for example, all of the battery cells comprised by the battery modules and different from the first battery cell may at least partly discharged in accordance with a predetermined order at least under the second condition, the order being defined depending on a spatial distance with respect to the first battery cell and/or depending on a thermal resistance between the respective battery cells different from the first battery cell and the first battery cell. In this regard, safety can be increased even further since it may thereby be possible for the star-shaped discharge principle even to be implemented at the battery cell level rather than just at the battery module level.

The battery comprising the plurality of battery modules may be embodied as a high-voltage battery. Precisely in the case of high-voltage batteries, on account of their typically very high total capacities in the fully charged state, there is a particularly high hazard potential, in particular in the case of a thermal runaway of a battery cell of such a high-voltage battery. The method and its example variants explained in even greater detail below may thus particularly be advantageous precisely when applied to such a high-voltage battery. In this case, the battery modules can constitute all the battery modules comprised by the high-voltage battery, or else alternatively only a portion of all the battery modules provided by such a high-voltage battery. In other words, the plurality of battery modules comprised by the battery can constitute all the battery modules comprised by the battery, or the plurality of battery modules comprised by the battery can also constitute only a subset, in particular a proper subset, of all the battery modules comprised by the battery. The battery can for example also comprise a second subset of battery modules, which may not be discharged in the course of the emergency discharge process, e.g. because they may be very far away from the defective module and/or may be thermally insulated from the latter very well. Such criteria, too, can be predefined for example by the second condition mentioned above. By way of example, the second conditions can comprise or specify that a relevant battery module is discharged only if the relevant battery module is at the smallest distance with respect to the defective first module or is at a distance with respect to this first module which is less than a predetermined limit value, and/or the relevant battery module has the smallest thermal resistance with respect to the defective first module or has a thermal resistance with respect to the first module which is less than a predetermined limit value.

In this case, a respective battery module can comprise just a single battery cell, but preferably a plurality of battery cells, for example lithium-ion cells. In this case, a battery module can define a cell group composed of a plurality of such battery cells. In this case, such a cell group can optionally be arranged in a common module housing or be arranged in a common module frame and/or in a common battery housing compartment and/or have a common clamping device.

In order to detect the specific critical state, the battery can additionally have a suitable detection device. The easiest way of being able to detect such a specific critical state is on the basis of a sensed temperature assigned to the at least one first battery cell. One or more temperature sensors may usually be provided in battery modules anyway, and allow temperature monitoring for the individual battery cells comprised by a relevant battery module. In this case, a cell-accurate implementation of the temperature monitoring need not necessarily be realized. In this case, it is also conceivable that the critical state can only be detected for a battery module as a whole, that is to say that it is possible to establish that at least one battery cell of the battery module has a critical state, but that the fact of which of the plurality of battery cells of this relevant battery module has this critical state need not necessarily be determinable. A higher spatial resolution with regard to the detection of the critical state of individual battery cells can be realized for example by providing a plurality of temperature sensors. However, a critical state of at least one battery cell can also additionally or alternatively be detected by other cell or module parameters as well, for example by detection of a pressure increase in the pressure within a battery cell or within a battery module, detection of a gas emerging from a battery cell or detection of a change in the gas composition within a battery module, detection of a voltage dip of a cell voltage or a battery module voltage, or other conspicuous electrical features during the monitoring of cell voltages, cell currents or other cell variables.

In an example, discharging of a battery module may not necessarily be intended to imply complete discharging of the battery module, rather it should also always be able to be understood to mean only partial discharging of such a battery module. Furthermore, an at least partial discharge of a battery module is understood to mean at least partial discharging of all of the cells comprised by this battery module. In this case, if the battery module is discharged to a specific state of charge or such that a specific state of charge limit value is undershot, all of the battery cells comprised by this battery module may correspondingly be discharged in such a way that they each have the specific state of charge or undershoot the specific state of charge limit value. If a battery module to be discharged has a plurality of battery cells, then the latter can be discharged all at the same time or temporally successively during the discharging of the battery module. In this case, said battery cells may be discharged at the same time since this is easier to realize in terms of circuitry since not every cell requires a dedicated circuit unit, rather e.g. the battery module as a whole, optionally together with still other modules, can then be connected up to a discharge terminal, which in the simplest case can be provided by the output terminals of the HV (high-voltage) battery, in order to realize the discharging, as will be explained in greater detail later, e.g. via motor vehicle-internal electrical consumers or via motor vehicle-external electrical consumers, where in that case, too, a coupling may be effected via the motor vehicle-internal charger. Discharging by short-circuiting of cells or modules may not be provided in this case. In other words, discharging may be effected by a measure that is different from short-circuiting. As a result, safety can be increased further and thermal propagation can be inhibited more efficiently.

In accordance with a further very advantageous example configuration, the second condition comprises a present state of charge of a respective second battery module being greater than a predetermined first state of charge limit value, which may be between 30 percent and 50 percent. The state of charge, also abbreviated to SOC, may typically be specified in percent, where a state of charge of 100 percent may correspond to a full charge of the relevant battery module or of the relevant battery cell, and 0 percent may correspond to a maximally discharged state of the relevant battery module or of the relevant battery cell. A fully charged battery burns very intensely, while a half fully charged battery often only outgases and does not catch fire. A reduction of the state of charge to only 50 percent, for example, already makes it possible for the risk of a battery fire to be enormously reduced. Accordingly, it is also advantageous if firstly only cells or battery modules which have a higher state of charge may be discharged in accordance with the predetermined order. That is to say that if the state of charge of a battery module is already low enough, then it is no longer necessary for this battery module to be discharged further. In this way, that is to say by providing such an additional second condition, what can be realized is that all battery modules of the battery can be brought to a state of charge below such a first state of charge limit value significantly more rapidly. In this regard, the battery can be converted particularly rapidly to a relatively noncritical state in which, if appropriate, thermal propagation of the individual cells or modules is still possible, but has a significantly reduced probability of leading to a battery fire. The hazard potential stemming from such a high-voltage battery in the case of a thermal runaway of a cell can thus be significantly reduced. In other words, even if a corresponding battery module is discharged in accordance with the predetermined order, it can be provided that this battery module need not necessarily be fully discharged, that is to say not as far as a state of charge of 0 percent, but rather only until a predetermined state of charge limit value corresponding for example to the first state of charge limit value defined here is reached.

In a further advantageous example configuration, the plurality of battery modules comprise at least one second battery module and at least one third battery module, the at least one second battery module being at a smaller distance from the first battery module than the at least one third battery module and/or a thermal resistance between the first and second battery modules being smaller than the thermal resistance between the first and third battery modules, a discharge process of the at least one third battery module being initiated only under the at least one third condition that the state of charge of at least the at least one second battery module has a maximum magnitude equal to a predetermined second state of charge limit value. In principle, this second state of charge limit value can be chosen differently than the first state of charge limit value mentioned above, but may correspond thereto or may likewise be between 30 percent and 50 percent. What can thus be realized by this advantageous embodiment is that, for example, firstly the battery modules in the immediate vicinity of the first, defective, battery module may be discharged, at least to a noncritical state of charge, and it is only when the latter has been reached that the discharging of the next battery modules is begun. The spreading of thermal propagation can be inhibited particularly efficiently as a result.

In a further advantageous example configuration, all of the battery modules which may be at a distance from the first battery module which is in a specific common distance range and/or have a thermal resistance with respect to the first battery module which is in a specific common resistance range may be discharged at least partly simultaneously. Significantly faster discharging can be achieved as a result, in particular in comparison with temporally sequential discharging of individual battery modules or even individual battery cells. Moreover, this configuration may in turn based on the insight that a thermal runaway of a battery module generally spreads with equal probability in all spatial directions, particularly in the case of an approximately identical thermal resistance. In other words, if the discharging firstly began for only one adjacent battery module, then in the meantime the thermal propagation could spread unimpeded in another direction and efficient inhibiting may no longer possible. The at least partly simultaneous discharging of all battery modules situated in an identical common distance range enables inhibiting to be effected isotropically and more efficiently. At the same time, the example also enables discharge measures that allow rapid discharging of a plurality of battery modules at the same time, as can be realized by the discharge measures explained in greater detail later.

In an example, therefore, all battery modules which are closest to the first battery module and which are at least approximately at an identical distance with respect to the first battery module can be discharged first. Afterward, the battery modules which are somewhat further away and which likewise are all approximately at an identical distance with respect to the first battery module may be discharged. It is thereby possible to realize as it were a ring-shaped or star-shaped discharge strategy which enables thermal propagation to be inhibited with maximum efficiency.

In a further very advantageous example configuration, the first battery module may not be discharged if the specific critical state is a specific first critical state, particularly if a temperature assigned to the first battery module or to the at least one first battery cell is greater than a predetermined first temperature limit value, and/or a state of charge of the first battery module has a maximum magnitude equal to a predetermined third state of charge limit value, which can in turn correspond to the first and/or second state of charge limit value, and which likewise may be between 30 percent and 50 percent.

In principle, therefore, the first battery module which is initially affected by the fault state, that is to say the battery cell having the specific first critical state, can likewise be discharged. However, such discharging of the first battery module may be dispensed with in two cases, namely firstly if the state of charge of this battery module is already below a noncritical value that can be predefined by the predetermined third state of charge limit value, and secondly if the specific critical state constitutes a specific first critical state, which can be characterized for example by the fact that the temperature assigned to the at least one first battery cell is greater than a predetermined first temperature limit value. However, such a first critical state may also be able to be characterized by some other cell variable that is in a specific critical range, for example the variables already described above, such as pressure, gas composition or the like. In this case, the first critical state defines in particular a state of the battery module in which a thermal runaway, and primarily catching fire or fire of the relevant module, can no longer be stopped. In this state, discharging of this relevant first battery module makes hardly any sense, if this is actually still possible from a technical standpoint, since the thermal runaway of the relevant module can no longer be stopped by this way anyway. This is the case for example if the temperature of the relevant module or of at least one battery cell comprised by this module exceeds 140° C. In this case, therefore, it may advantageously be possible to dispense with the discharge of the first battery module, and to proceed directly to the discharging of the next battery modules in accordance with the predetermined order. The chance of being able to stop the thermal propagation is additionally increased as a result.

In an example, the predetermined first temperature limit value is in a range of between 80° C. and 140° C., for example, between 100° C. and 140° C., or for example at 140° C. itself. Specifically, 140 degrees may be the latest point at which a thermal runaway of the relevant battery module can no longer be stopped and discharging of this battery module can be dispensed with in favor of faster discharging of the surrounding battery modules.

Accordingly, it may also be advantageous if the first battery module is discharged temporally before the battery modules different from the first battery module if the specific critical state is a specific second critical state, which may be present in particular if a temperature assigned to the first battery module or to the at least one first battery cell is less than or equal to a predetermined second temperature limit value, which for example can correspond to the first temperature limit value defined above, and is greater than a third temperature limit value, which is less than the second temperature limit value. To mention one example, the third temperature limit value can be chosen to be 80° C., for example, and the first and second temperature limit values can be chosen to be 140° C. This would mean that if the temperature is in a range of between 80° C. and 140° C., the relevant battery module, here the first battery module, may be discharged, in particular still temporally before the other battery modules, while if the temperature of this battery module or of the first battery cell comprised by the latter is greater than 140° C., the discharging of this first battery module may be dispensed with, and the method proceeds directly to the discharging of the other battery modules in accordance with the predetermined order. At lower temperatures that nevertheless imply a critical state of the relevant first battery module, additional discharging of the first battery module makes it possible to prevent a thermal runaway or a fire of the first battery module or at least to reduce the probability thereof. In this case, therefore, it may be advantageous if the first battery module is also discharged temporally before the other battery modules.

Here as well, however, in an example, the discharging of the battery module for the case where the battery module is in the second specific critical state may take place only if its state of charge is also greater than the predetermined third state of charge limit value defined above. If its state of charge is low anyway, then here as well it is once again possible to proceed directly to the discharging of the other battery modules. This can be the case for example if the relevant defective battery module has already partly discharged itself on account of a short circuit, which for example might also have caused the thermal runaway of the relevant battery cell.

There are then a number of possibilities for discharging the relevant battery modules; these possibilities will be explained in greater detail below and are also combinable in any desired way, in principle.

In accordance with one advantageous example, it is provided here that during the discharging of at least one battery module of the battery modules, charge may be transferred to at least one battery module which is to be discharged later in accordance with the predetermined order or is not to be discharged in accordance with the second condition and which has a state of charge different from a full charge. In other words, the discharging of battery modules can be realized by transferring their charge to other modules, further away from the relevant first module, provided that these are not fully charged. In this regard, battery-internal redistribution of the charge between the individual high-voltage battery modules can advantageously be realized. In other words, a redistribution of the capacity in the battery is thus implemented. What is accordingly prioritized here is the discharge of the “overheated” battery module and the directly surrounding battery modules, for example at a subcritical state of charge with regard to fire behavior, for example of 35 percent. The electrical energies are then accordingly taken up by other cell modules, which accordingly become charged further, in which case battery modules that are further away may be charged, in particular according to the star method already described above. In this regard, storage reserves that are still present within the battery but are at a greater distance from the critical module can be used in order firstly progressively to discharge the spatial regions directly adjoining said critical module by the discharge processes described and thereby to stop the thermal propagation. This is advantageous primarily in combination with the additional discharge possibilities explained in even greater detail below, since the discharge process of directly adjacent modules can thereby be accelerated by these additional energy reserves.

In accordance with a further very advantageous example configuration, at least one of the battery modules to be discharged may be discharged by a vehicle-external energy sink, in particular by one of the following measures: electrical connection to a motor vehicle-external external and/or consumer, electrical connection to a motor vehicle-external electricity grid, and/or electrical connection to a ground terminal. For this purpose, the motor vehicle, for example via its conventional charging terminal, can be electrically coupled to such a vehicle-external energy sink in order to realize the discharging of the relevant battery modules as described. In this case, a multitude of different energy sinks can be used as vehicle-external energy sinks. By way of example, motor vehicle-external energy stores can be used for this purpose, for example likewise batteries or high-voltage batteries, which for example can be provided by other motor vehicles or for example can also be brought by the fire department. Equally, motor vehicle-external consumers can be provided by other vehicles or likewise by the fire department, for example, the energy drawn from the battery cells or battery modules to be discharged being consumed by said consumers. Primarily the coupling to a motor vehicle-external electricity grid may particularly be advantageous. The latter can be provided for example by a domestic service connection or else by a bidirectional charging point. Very high discharge powers enabling the battery modules to be discharged extremely rapidly can be provided precisely by such a charging point. A bidirectional charging functionality of the motor vehicle can also be used when discharging the battery modules via the energy stores or consumers described above. In all these cases, therefore, the motor vehicle can be connected via a conventional charging cable, for example, to other electrical storage media or consumers, for example other HV batteries of other vehicles, or to batteries and/or consumers provided by the fire department, or a bidirectional charging point. Moreover, it is conceivable for the battery or the motor vehicle comprising the latter to have a connector or terminal that can be grounded, such that the electrical energy drawn from the battery modules to be discharged can be dissipated into the ground. The last-mentioned possibility may then correspondingly advantageously always available, that is to say even without having to wait for the fire department or relying on the presence of a charging point or other motor vehicle or external consumers.

In a further very advantageous example configuration, at least one of the battery modules to be discharged is discharged by a motor vehicle-internal consumer which is different from a battery module and/or a battery cell. This has the great advantage that such a discharge possibility is available at any time, in particular in contrast to a discharge by a motor vehicle-external consumer. In addition, numerous consumers that can be used for discharging the battery are available within the vehicle. For this purpose, provision can be made for said consumers, even if they are currently not required, to be activated for providing the emergency discharge described or even to be operated in a special operating mode, as will now be explained in greater detail below. In this case, it may particularly be advantageous if the consumer constitutes at least one or else a plurality of the following: a high-voltage heater and/or a heating device, for example a seat heating system, mirror heating system or window heating system, an air-conditioning apparatus, in particular an electrical air-conditioning compressor, and/or a radiator fan, an energizable chassis component, an electric motor of the motor vehicle that is operated in idle mode, an electronic component, a charger in a power loss mode, an illuminant, a transmission controller, a loudspeaker and/or horn, a pump, an antenna, an infotainment system and/or a medium-voltage and/or low-voltage battery. A suitable high-voltage heater is for example a high-voltage heater for interior heating and/or else a high-voltage heater for the cooling water circulation of units, but not for the high-voltage battery itself, in order that the latter, under certain circumstances, can also continue to be cooled, which is advantageous in order to counteract the thermal runaway or the thermal propagation. With regard to the use of an air-conditioning apparatus or the radiator fan, it is additionally possible to set an adjustable air-conditioning function or fan function to maximum, that is to say to set it to an operating setting with a maximum performance level, such that energy can also be maximally consumed as a result. Energized or energizable chassis components which can likewise be actively energized for discharging purposes are for example chassis components for electronic active roll stabilization, for an E-Active Body Control system and/or controlled air springs or the like. The electric motor, too, can be used as a consumer and can be operated for example in a targeted manner in idle mode at a high rotational speed, in particular forward and/or backward by switching over the polarity. Power electronics, too, in particular also in control units, can be used and/or driver assistance systems. For this purpose, by way of example, high computing powers can be called up in a targeted manner in order to increase the reactive power. By way of example, in an emergency operating mode, mathematic algorithms can be solved within loops in a targeted manner. Moreover, illuminants, too, in particular various lights or lighting devices of the vehicle, both for interior lighting and for exterior lighting, for example the headlights, can be activated and thus used for discharging. With the use of loudspeakers, too, it is possible to use loudspeakers both in the interior, e.g. a bass box in the interior, and in the exterior area, e.g. an AVAS exterior sound box. As antennas, various receiving antennas for receiving and/or transmitting can likewise be used as corresponding consumers which can be activated in a targeted manner. Appropriate pumps are for example water pumps, for example in the cooling circuit, or the like.

Overall, numerous consumption possibilities may thus be available which in total can consume a very large amount of energy within a very short time. Particularly rapid discharging of the battery modules is made possible as a result.

Furthermore, the examples also relates to a control device for a motor vehicle for controlling discharging of battery modules of a battery of the motor vehicle in the case of a fault state of at least one of the battery modules, a respective one of the plurality of battery modules having at least one battery cell. In this case, the control device is designed, under at least one first condition that at least one first battery cell of a first battery module of the plurality of battery modules has at least one specific critical state, to initiate at least partial discharging of up to all (subsets of) respective second battery modules, from among the battery modules which are different from the first battery module in accordance with a predetermined order at least under a second condition, the order being defined depending on a spatial distance between the respective battery modules different from the first battery module and the first battery module and/or depending on a thermal resistance between the respective battery modules different from the first battery module and the first battery module.

The advantages mentioned for the method according to the described examples and the configurations thereof are applicable to the control device according to described examples in the same way. The control device can be comprised for example by the battery, preferably embodied as a high-voltage battery.

Furthermore, a motor vehicle comprising a control device according to the examples is also intended to be regarded as included.

In an example, the control device for the motor vehicle can comprise a data processing device or a processor device configured to carry out described example of the method. For this purpose, the processor device can comprise at least one microprocessor and/or at least one microcontroller and/or at least one FPGA (Field Programmable Gate Array) and/or at least one DSP (Digital Signal Processor). Furthermore, the processor device can have program code configured, when executed by the processor device, to carry out the described example of the method. The program code can be stored in a data memory of the processor device.

The described examples also include developments of the control device according to the described examples which have features such as have already been described in association with the developments of the method according to the described examples. For this reason, the corresponding developments of the control device are not described again here.

The motor vehicle may be configured as an automobile, in particular as a car or truck, or as a passenger bus or motorcycle.

The described examples also encompass the combinations of the features of the examples described. The described examples thus also encompass realizations which each have a combination of the features of a plurality of the examples described, provided that the examples were not described as being mutually exclusive.

### BRIEF DESCRIPTION OF THE DRAWINGS

These and other aspects and advantages will become more apparent and more readily appreciated from the following description of the examples, taken in conjunction with the accompanying drawings of which:

FIG. 1 shows a schematic illustration of a high-voltage battery with a plurality of battery modules at a first point in time, one of which battery modules is in a critical state and is discharged via a consumer in accordance with an example;

FIG. 2 shows a schematic illustration of the battery from FIG. 1 at a later point in time, the battery modules closest to the critical battery module being discharged via the consumer, in accordance with a further example;

FIG. 3 shows a schematic illustration of the battery from FIG. 1 and FIG. 2 at an even later point in time, at which the battery modules that are even further away from the critical battery module are discharged, in accordance with an example;

FIG. 4 shows a schematic illustration of a battery with a defective battery module in accordance with a further example; and

FIG. 5 shows a schematic illustration of the battery from FIG. 4, in which the battery modules closest to the critical battery module are discharged by their charge being transferred to battery modules further away, in accordance with a further example.

### DETAILED DESCRIPTION

The examples explained below may be examples of an invention. In the examples, the described components may each constitute individual features which may be considered independently of one another and which each may also develop the examples of the invention independently of one another. Therefore, the disclosure is also intended to encompass combinations of the features of the examples other than those presented. Furthermore, the described examples are also able to be supplemented by further features from among those already described.

In the figures, identical reference signs in each case designate functionally identical elements.

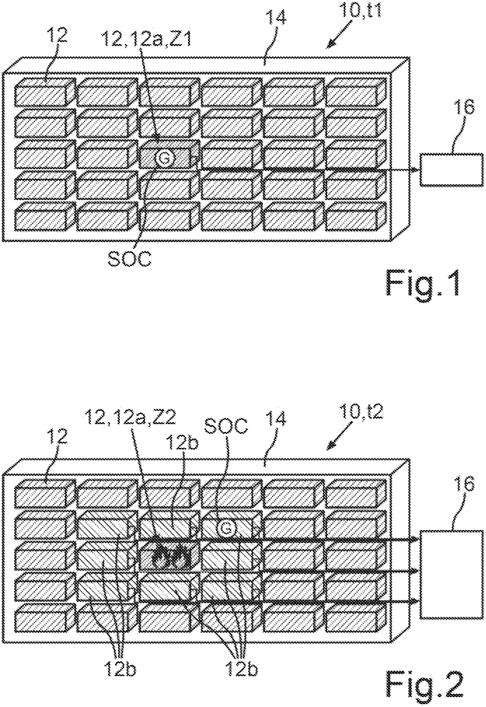

FIG. 1 shows a schematic illustration of a battery 10, embodied as a high-voltage battery in this example, at a first point in time t1 in accordance with the example. In this example, the battery 10 has a plurality of battery modules 12, each of which in turn can comprise a plurality of battery cells, which are not explicitly illustrated in the present case. Furthermore, only some of the battery modules 12 are provided with a reference sign, for reasons of clarity. The battery modules 12 can additionally be arranged in a common high-voltage battery housing 14. Such a high-voltage battery 10 can be arranged for example in an underbody region of a motor vehicle.

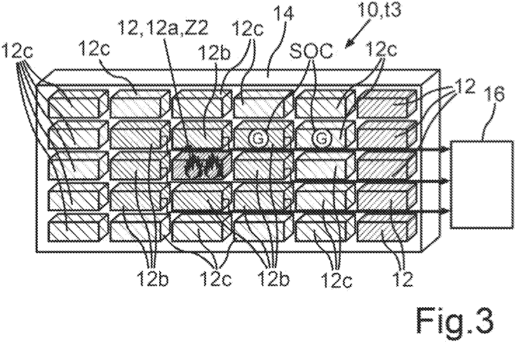

In this case, the fire hazard stemming from such a high-voltage battery 10 scales with the state of charge thereof. In other words, a fully charged battery 10 has the greatest energy content and thus the greatest fire hazard in the event of an accident. Accordingly, a fully charged battery burns very intensely, while a half fully charged battery often only outgasses and does not catch figure. A significantly drained battery has a very high probability of not catching fire at all. The examples use this insight, then, in order to enable targeted draining or consuming of the energy stored in such a battery 10 according to the “star method” described in greater detail below. In principle, such a battery 10 can be discharged with the aid of consumers 16, which can be manifested in various ways. One such consumer 16 is illustrated by way of example in FIG. 1, FIG. 2 and FIG. 3. Said consumer 16 can be either a vehicle-internal consumer or a vehicle-external consumer. Once again various consumers are in each case suitable here. In principle, appropriate vehicle-internal consumers are any high-voltage, medium-voltage or low-voltage electrical systems and/or electronic systems (collectively may be referred to as electrical consumers), which entail the potential of consuming a high electrical energy content within a relatively short time, in particular by way of reactive power. Besides such consumers which are present in the vehicle anyway and which perform other tasks and functions in the normal state, components introduced separately for this purpose can optionally also be provided as such consumers 16, which components are then configured to convert electrical energy into heat and/or light and/or sounds and/or electromagnetic waves having any desired wavelengths and/or kinetic energy. In order to draw energy from the battery 10 by use of vehicle-external consumers, it is also possible to use bidirectional charging, for example. By this way, the vehicle battery 10, via a charging cable not illustrated in more specific detail here, can be connected to other electrical storage media, for example other high-voltage batteries of another vehicle, or from the fire department, or a connector which can be grounded could also be used in order to dissipate the energy to be drawn from the battery 10 into the ground.

There are in turn a number of possibilities in order then to discharge the battery 10 as efficiently as possible; these possibilities will now be explained in greater detail below. These discharge methods begin firstly with the detection of a specific critical state of at least one of the battery modules 12a, as is illustrated at the first point in time t1 in FIG. 1. Such a critical state may be present if for example an irregularly boosted temperature, for example of between 80° C. and 140° C. is detected in a cell module 12, such as in a first cell module 12a in this example. A critical state may also be deemed to have been detected if an even higher temperature is detected. In this case, it may be advantageous primarily if a distinction is drawn between at least two different critical states Z1, Z2. A first critical state Z1 is illustrated for the first battery module 12a in FIG. 1, for example, and the second critical state Z2 in FIG. 2. If the temperature of the relevant cell 12a is for example in a first temperature range, for example between 80° C. and 140° C., then this can correspond to the first critical state Z1, and if by contrast the temperature is even higher then this can correspond to the second critical state Z2. The temperature of the cells of the individual battery modules 12 can moreover be detected by one or more temperature sensors per battery module 12, which are installed in particular within each battery module 12. Already existing temperature sensors can primarily be used for this purpose in an efficient way. Thus, if a critical state Z1, Z2 of a relevant battery module 12a is detected, then it is possible to initiate selective discharging, e.g. firstly of this corresponding battery module 12a, via the electrical consumers 16 mentioned. A reduction of the state of charge of the relevant cell module 12a can be achieved as a result, and so possible development of a fire can be prevented early and the battery module 12a only outgasses without flames. In an example, discharging of the battery module 12a, as is illustrated in FIG. 1, may take place or to be initiated only if said battery module 12a is in the defined first critical state Z1. If the thermal propagation within the battery module 12a has already progressed too far, for example, and if the temperature of the battery module 12a has already indeed increased too much, such that it is no longer possible to stop this module 12a from catching fire, which is characterized by the second critical state Z2, then discharging of the relevant module 12a is dispensed with and the method proceeds directly to the discharging of adjacent battery modules 12b, as is illustrated for a later second point in time t2 in FIG. 2.

In this case, FIG. 2 shows in particular the battery module 10 from FIG. 1 at the later point in time t2 relative to the first point in time t1. The battery modules closest to the critical battery module 12a are designated by 12b in the present case. These battery modules 12b may then be discharged next, in particular once again via one or more of the consumers 16 mentioned above. The battery modules 12 need not necessarily be completely discharged in accordance with this discharge strategy. On the contrary, these battery modules 12b may be discharged only until a specific state of charge limit value G is reached or undershot, which may be between 30 and 50%. If one or more of these closest battery modules 12b already has a state of charge SOC that is less than this limit value G, then targeted discharging of these modules 12b can also be dispensed with and it is possible to proceed directly to the next battery modules 12. The trigger for discharging these battery modules 12b thus constitutes a battery module 12a in a critical state, in particular in the first critical state Z1 or, as in the present case, in the second critical state Z2. Discharging of the battery module 12a which is in the first critical state Z1 can likewise be dispensed with as well if this battery module already has an initial state of charge SOC that is less than this predetermined state of charge limit value G. In other words, if an initial battery module 12a is present whose initial temperature exceeds 140° C., or an initial battery module 12a with an increased temperature below a noncritical state of charge value G, for example between 30 and 50%, then initial discharging of this first battery module 12a can be dispensed with, and the closest battery modules 12b can directly be selectively discharged. In other words, if these closest battery modules 12b are all discharged below the predefined critical state of charge value G, then the nearest adjacent cell modules 12c can in turn be discharged, as is illustrated at an even later third point in time t3 in FIG. 3. In this regard, the method can continue progressively until all the battery modules 12 are discharged or are at least discharged below the predefined critical state of charge limit value G. The thermal resistance between the battery modules 12 can optionally also be taken into account when defining the discharge order. By way of example, if one of the modules 12b closest to the first module 12a is thermally insulated from the first module 12a better than a module 12c that is further away is thermally insulated from the first module 12a, then firstly the module 12c that is further away can also be discharged before the closest module 12b. Often, however, the modules 12 are embodied identically and are thermally insulated from one another in an identical manner, such that the thermal resistance increases with increasing spatial distance with respect to the first battery module 12a, such that even taking the thermal resistance into account, the resulting discharge order may be the same as may result if only the spatial distance were taken into account.

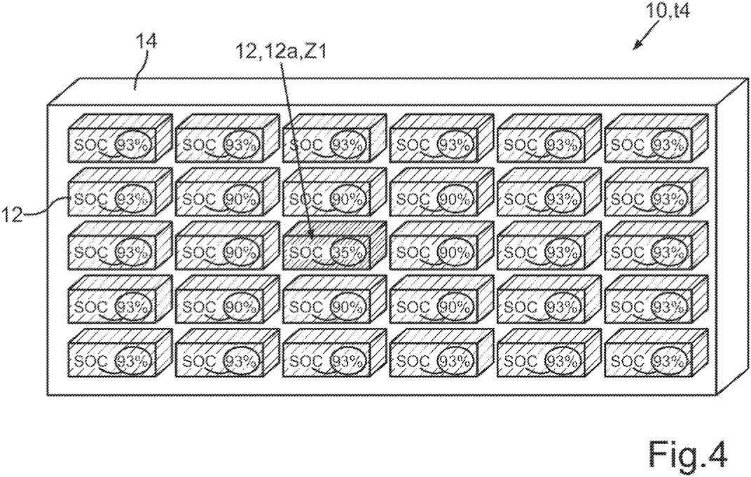

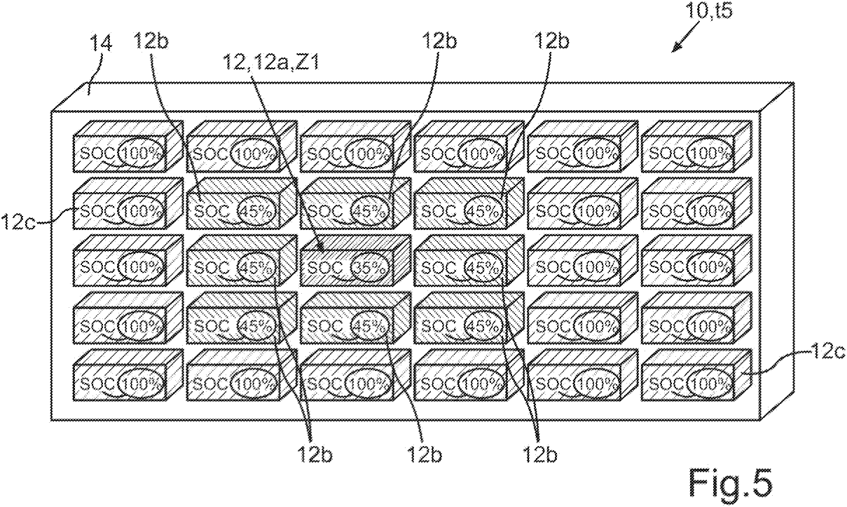

However, discharging in accordance with this procedure can be realized not just by use of the electrical consumers 16 described, but additionally or alternatively also by battery-internal redistribution of the states of charge SOC between the individual high-voltage battery modules 12, as is illustrated in FIGS. 4 and 5. FIGS. 4 and 5 each show a further example of a high-voltage battery 10, which can be constructed in particular as described above. In this example, the first battery module 12a once again has a critical state Z1, Z2. In particular, FIG. 4 already shows a state of this battery module 12a in which its state of charge SOC is already very low and is only 35% in this example. This may have been achieved for example by previous targeted discharging of this battery module 12a as described for example in relation to FIG. 1, or, as is intended to be illustrated in this example, by transfer of charge to battery modules 12c that are further away.

In this example, the other battery modules 12 have a respective state of charge SOC that is different from full charge, that is to say is different from 100%. In this example, the battery modules 12c that are the furthest away or at least further away from the critical cell or the critical battery module 12a are then used in order to take up energy from the critical battery module 12a and the battery modules 12b closest to the critical battery module. In other words, here as well once again the battery modules 12b closest to the critical cell module 12a are discharged first, in particular before the battery modules 12c that are even further away, by at least part of the charge taken up in said closest battery modules 12b being transferred to the modules 12c that are further away. As is illustrated in FIG. 5, the closest battery modules 12b may be for example correspondingly discharged from an initial state of charge of 90%, as is illustrated in FIG. 4, to now 45%, as illustrated in FIG. 5, while the modules 12c that are further away were charged from initially 90% firstly to 93% by taking up the charge of the defective module 12a, as illustrated at an earlier point in time t4 in FIG. 4, and then to now 100% by taking up charge of the module 12b, as illustrated at a later point in time t5 in FIG. 5. This concept thus involves implementing a redistribution of the charge within the battery 10. What is prioritized is the discharge of the overheated module 12a until for example a noncritical state of charge SOC in relation to fire behavior is reached, for example of 35%. The electrical energy is taken up by the other cell modules 12c, which accordingly become charged further. In this case, cell modules 12c that are further away may be charged, in particular once again according to the star method already described above. If permitted by the capacitive reserves, the adjacent battery modules 12b can also be discharged at the expense of the battery modules 12c that are further away.

This strategy may be particularly advantageous primarily in combination with the above-described discharge via a consumer 16. The battery-internal charge transfer additionally makes it possible to gain a time advantage in order to inhibit the thermal propagation. The outer battery modules 12c can then be discharged via battery-external consumers 16, for example.

In order to implement the discharge strategies described, the individual battery modules 12 or the cells thereof can be interconnected with one another in a correspondingly suitable manner. Suitable implementations are sufficiently known here to the person skilled in the art and are therefore not explained in any greater detail.

Overall, the examples show use of energy consumers to reduce the capacity of a high-voltage battery in the imminent event of an accident. The state of charge of overheated battery modules can be lowered in a targeted manner by the star method described. A lower state of charge of an overheated battery module can avert a fire of the corresponding battery module and thus spreading of a fire. Battery modules having a low state of charge can maximally outgas and are significantly less dangerous than a fire. If the overheated battery module is past saving, that is to say a fire arises there, the states of charge of the adjacent battery modules can accordingly be reduced to a noncritical state of charge, with the result that the fire cannot spread.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. A method of discharging a plurality of battery modules of a battery in case of a fault state of at least one of the battery modules, a respective battery module of the plurality of battery modules having at least one battery cell, the method comprising:
under at least one first condition that at least one first battery cell of a first battery module of the plurality of battery modules has at least one critical state, respective second battery modules, from among the battery modules, which are different from the first battery module, are at least partly discharged in accordance with a determined order at least under a second condition,
the order being determined depending on a spatial distance between the respective second battery modules different from the first battery module and the first battery module and/or depending on a thermal resistance between the respective second battery modules different from the first battery module and the first battery module.

2. The method according to claim 1, wherein
respective battery cells comprised by the respective second battery modules and different from the first battery cell are at least partly discharged in accordance with a determined order at least under the second condition, the order being determined depending on a spatial distance with respect to the first battery cell and/or depending on a thermal resistance between the respective battery cells different from the first battery cell and the first battery cell.

3. The method according to claim 1, wherein
the second condition comprises a present state of charge (SOC) of a second battery module, from among the respective second battery modules being greater than a determined state of charge limit value (G), which is between about 30% and about 50%.

4. The method according to claim 3, wherein,
the plurality of battery modules comprise at least one second battery module and at least one third battery module, the at least one second battery module being at a smaller distance from the first battery module than the at least one third battery module and/or a thermal resistance between the first and second battery modules being smaller than a thermal resistance between the first and third battery modules,
a discharge process of the at least one third battery module being initiated under at least one third condition that a state of charge (SOC) of at least the at least one second battery module has a maximum magnitude equal to a determined state of charge limit value (G).

5. The method according to claim 1, wherein
second battery modules, from among the second battery modules, which are at a distance from the first battery module which is in a common distance range and/or have a thermal resistance with respect to the first battery module which is in a common resistance range, are discharged at least partly simultaneously.

6. The method according to claim 1, wherein
the first battery module is not discharged if the at least one critical state is a state in which a temperature assigned to the first battery module or to the at least one first battery cell is greater than a determined first temperature limit value, and/or a state of charge (SOC) of the first battery module has a maximum magnitude equal to a predetermined state of charge limit value (G).

7. The method according to claim 3, wherein
to at least partly discharge the respective second battery modules, during discharging of at least one second battery module of the battery modules, charge is transferred to the at least one battery module which is to be discharged later in accordance with the determined order, or is not to be discharged in accordance with the second condition and which has a state of charge (SOC) different from a full charge.

8. The method according to claim 1, wherein
to at least partly discharge the respective second battery modules, at least one of the second battery modules to be discharged is discharged by a vehicle-external energy sink according to at least one measure among measures including:
electrical connection to a motor vehicle-external energy store and/or electrical consumer; and/or
electrical connection to a motor vehicle-external electricity grid; and/or
electrical connection to a ground terminal.

9. The method according to claim 1, wherein to at least partly discharge the respective second battery modules, at least one of the second battery modules to be discharged is discharged by a motor vehicle-internal electrical consumer which is different from the battery modules and/or the at least one battery cell according to at least one electrical consumer, among the following electrical consumers:
a high-voltage heater and/or heating device;
an air-conditioning apparatus and/or a radiator fan;
an energizable chassis component;
an electric motor of the motor vehicle that is operated in idle mode;
an electronic component;
a charger in a power loss mode;
an illuminant;
an electric transmission controller;
a loudspeaker and/or a horn;
a pump;
an antenna;
an infotainment system; and/or
a medium-voltage and/or low-voltage battery.

10. A control device of a motor vehicle to control discharging a plurality of battery modules of a battery of the motor vehicle in case of a fault state of at least one of the battery modules among the plurality of battery modules, a respective battery module of the plurality of battery modules having at least one battery cell, the control device comprising:
a memory to store a program code; and
a processor coupled to the memory and to execute the program code to control a process to,
under at least one first condition that at least one first battery cell of a first battery module of the plurality of battery modules has at least one critical state, initiate at least partial discharging of respective second battery modules, from among the battery modules, which are different from the first battery module, in accordance with a determined order at least under a second condition,
the order being determined depending on a spatial distance between the respective second battery modules different from the first battery module and the first battery module and/or depending on a thermal resistance between the respective second battery modules different from the first battery module and the first battery module.

11. The control device according to claim 10, wherein the process is to control to at least partially discharge respective battery cells comprised by the respective second battery modules and different from the first battery cell in accordance with a determined order at least under the second condition, the order being determined depending on a spatial distance with respect to the first battery cell and/or depending on a thermal resistance between the respective battery cells different from the first battery cell and the first battery cell.

12. The control device according to claim 10, wherein
the second condition comprises a present state of charge (SOC) of a second battery module, from among the respective second battery modules being greater than a determined state of charge limit value (G), which is between about 30% and about 50%.

13. The control device according to claim 12, wherein,
the plurality of battery modules comprise at least one second battery module and at least one third battery module, the at least one second battery module being at a smaller distance from the first battery module than the at least one third battery module and/or a thermal resistance between the first and second battery modules being smaller than a thermal resistance between the first and third battery modules,
a discharge process of the at least one third battery module being initiated under at least one third condition that a state of charge (SOC) of at least the at least one second battery module has a maximum magnitude equal to a determined state of charge limit value (G).

14. The control device according to claim 10, wherein the process is to control to discharge at least partly simultaneously the second battery modules, from among the battery modules, which are at a distance from the first battery module which is in a common distance range and/or have a thermal resistance with respect to the first battery module which is in a common resistance range.

15. The control device according to claim 10, wherein
the first battery module is not discharged if the at least one critical state is a state in which a temperature assigned to the first battery module or to the at least one first battery cell is greater than a determined first temperature limit value, and/or a state of charge (SOC) of the first battery module has a maximum magnitude equal to a predetermined state of charge limit value (G).

16. The control device according to claim 12, wherein
to at least partly discharge the respective second battery modules, during discharging of at least one second battery module of the battery modules, the process is to control transfer a charge to the at least one battery module which is to be discharged later in accordance with the determined order, or is not to be discharged in accordance with the second condition and which has a state of charge (SOC) different from a full charge.

17. The control device according to claim 10, wherein
to at least partly discharge the respective second battery modules, the process is to control to discharge at least one of the second battery modules to be discharged by a vehicle-external energy sink according to at least one measure among measures including:
electrical connection to a motor vehicle-external energy store and/or electrical consumer; and/or
electrical connection to a motor vehicle-external electricity grid; and/or
electrical connection to a ground terminal.

18. The control device according to claim 10,
wherein to at least partly discharge the respective second battery modules, the process is control to discharge at least one of the second battery modules to be discharged by a motor vehicle-internal electrical consumer which is different from the battery modules and/or the at least one battery cell according to at least one electrical consumer, among the following electrical consumers:
a high-voltage heater and/or heating device;
an air-conditioning apparatus and/or a radiator fan;
an energizable chassis component;
an electric motor of the motor vehicle that is operated in idle mode;
an electronic component;
a charger in a power loss mode;
an illuminant;
an electric transmission controller;
a loudspeaker and/or a horn;
a pump;
an antenna;
an infotainment system; and/or
a medium-voltage and/or low-voltage battery.
